(19) United States
(12) Patent Application Publication
(10) Pub. No.: US 2009/0043697 A1
(43) Pub. Date: Feb. 12, 2009

(54) System and method for repaying an obligation

(76) Inventors: Mitchell L. Jacobs, New York, NY (US); Noah Joseph Breslow, New York, NY (US)

Correspondence Address: ELLIOT FURMAN, 15 WEST 81ST STREET #11J, NEW YORK, NY, 10024, US

(21) Appl. No.: 12/187,095

(22) Filed: Aug. 6, 2008

Related U.S. Application Data
(60) Provisional application No. 60/954,185, filed on Aug. 6, 2007.

(51) Int. Cl. G06Q 40/00

(52) U.S. Cl. 705/39

(57) ABSTRACT

A method for repaying an obligation comprises periodically receiving into a merchant designated account an entirety of funds resulting from merchant sales made with a card product. A first amount related to the terms of the obligation is computed and the first amount is applied to the obligation. The amount remaining in the merchant designated account after applying the first amount to the obligation is transferred to a bank account accessible by the merchant. The steps are repeated until the obligation is satisfied. A system for repaying the obligation is in communication with an unmodified retail payment system. The system for repaying the obligation comprises at least one merchant designated account in communication with a network of the retail payment system, a master account in communication with the at least one merchant designated account, and an obligation processor in communication with the at least one merchant designated account and the master account.

This application claims the benefit of U.S. Provisional Application No. 60/954,185, filed Aug. 6, 2007, which is hereby incorporated by reference.

### BACKGROUND

Retail payment systems typically involve transactions between consumers and businesses. Retail payments are used to pay for the purchase of goods and services, and these goods and services may be purchased using a variety of payment instruments such as cash, checks, credit cards, or debit cards. The payment instruments may comprise a paper instrument or an electronic instrument.

In a retail payment system, a merchant processor is responsible for the creation, operation, processing, and maintenance of merchant accounts. All payments using card products, such as credit cards and debit cards, from a consumer to a merchant, are acquired, stored, and processed by the merchant processor. The merchant processor may be a bank or other financial institution, in which case the merchant processor is also an acquiring bank. Or, the merchant processor may be separate from, but interfaced to an acquiring bank. In either case, the merchant processor performs activities for the acceptance and settlement of card products and transactions. The merchant processor maintains a record of a merchant account identifier, such as a bank account number, designated by the merchant into which funds from daily sales should be deposited. Card products include any device or method for conveying account information from a consumer to a merchant for the purchase of goods and services, for example, credit cards, debit cards, charge cards, smart cards, RFID devices, wireless devices such as mobile phones configured for making automated retail purchases, online payment systems and methods, and the like.

In receiving transactions using card products, one or more networks may be used to approve transactions with the card product issuer, also referred to as the card issuer. No matter the specific network and no matter the specific protocols for approving and accepting card product transaction, the merchant processor maintains a file comprising approved transactions, including account identifiers, for each approved card product transaction, the amount of each transaction, and for each transaction or group of transactions, a merchant account identifier that identifies the bank account designated by the merchant into which proceeds from sales should be deposited.

Periodically, such as at the end of each day, the file is submitted in batches to the acquiring bank for interbank electronic funds transfers. The interbank transactions include depositing the amounts from the transactions, less fees such as a discount rate and interchange fees, from the acquiring bank into the merchant designated bank account. The interbank transactions also include the exchange of funds between the acquiring and the card issuer bank, and any other entities, institutions, or banks. One or more networks, including clearinghouses or wholesale payment systems are used for the interbank transactions. Examples include the Automated Clearing House (ACH), Fedwire, and the Clearing House Interbank Payment System (CHIPS).

Regardless of many things—the networks used, whether the merchant processor, the acquiring bank, the card issuer, and the issuer bank are distinct or, in whole or in part, the same part entities, of whether third parties act on behalf of the merchant processor or the acquiring bank as a middle man—the merchant receives payment by way of the file of transactions maintained and transmitted by the merchant processor according to standardized and well understood methods and systems for interbank transactions.

Retail payments systems such as just described, including any associated networks, and interbank and interchange processes, are well understood by those having ordinary skill in the art. Wholesale payment systems are also well understood by those having ordinary skill in the art. As a matter of background, the following is hereby incorporated by reference: “Retail Payment Systems,” Federal Financial Institutions Examination Council IT Examination Handbook, March 2004; “Wholesale Payment Systems,” Federal Financial Institutions Examination Council IT Examination Handbook, July 2004.

### SUMMARY

A method for repaying an obligation comprises periodically receiving into a merchant designated account an entirety of funds resulting from merchant sales made with a card product. A first amount related to the terms of the obligation is computed. The first amount is applied to the obligation. The amount remaining in the merchant designated account after applying the first amount to the obligation is transferred to a bank account accessible by the merchant. The steps are repeated until the obligation is satisfied. A system for repaying an obligation is in communication with a retail payment system. The system for repaying the obligation comprises at least one merchant designated account in communication with a network of the retail payment system. A master account is in communication with the at least one merchant designated account. And, an obligation processor is in communication with the at least one merchant designated account and the master account.

### BRIEF DESCRIPTION OF THE DRAWINGS

FIG. 1 shows a repayment system in communication with a prior art retail payment system.

FIG. 2 shows an exemplary method for repaying an obligation.

FIG. 3 shows a method for dynamic underwriting based on electronic transactions such as card transactions.

FIG. 4 shows a method for creating a merchant processor identifier database.

FIG. 5 shows a method of identifying a merchant processor and specifying the redirection of funds to a merchant designated account.

FIG. 6 shows another exemplary method for repaying an obligation.

### DETAILED DESCRIPTION

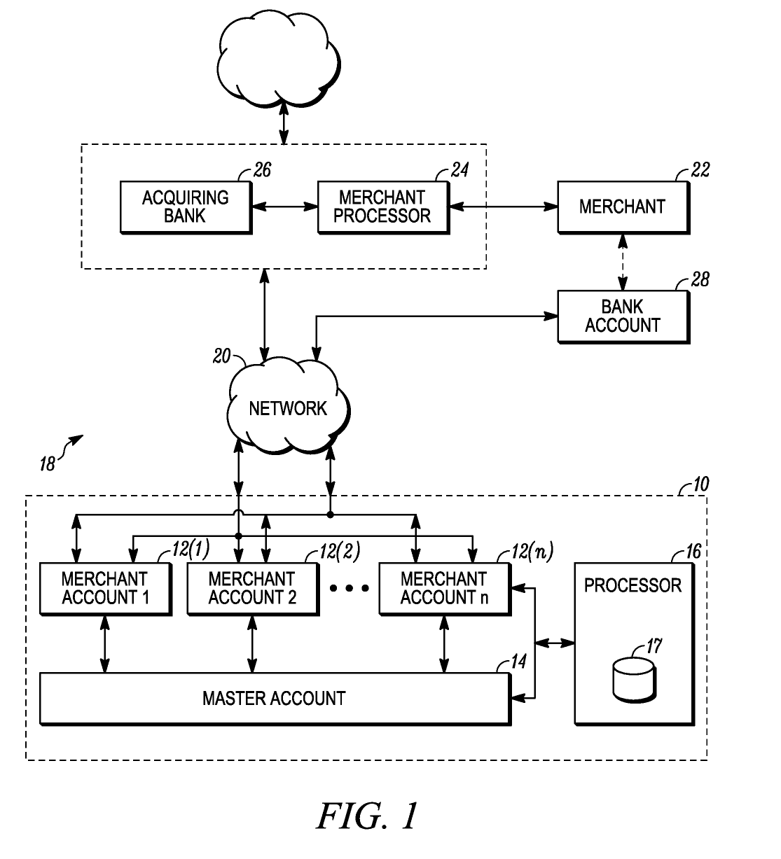

FIG. 1 shows a repayment system 10 in communication with a prior art retail payment system 18, the retail payment system including and operating as described above. The prior art retail payment system 18 comprises a network 20, a merchant 22, a merchant processor 24, an acquiring bank 26, and a bank account 28. It is appreciated by those skilled in the art that the retail payment system 18 may include many other elements such as merchants, processors, banks, and networks such as described above.

The repayment system 10 is in communication with retail payment system 18 through the network 20. The network 20 may comprise any network for electronic funds transfers, such as an Automated Clearing House (ACH) network. As is well understood, electronic fund transfers over a network such as network 20 are executed by submitting a file to the network. For example, a bank may submit an ACH file to the network. The file comprises amounts and account identifiers, such as account numbers and bank routing numbers, for each desired transaction. The ACH file is created and submitted according to National Automated Clearing House Association Rules. Of course, depending on the specific network, the format of the file and its submission may vary.

In any case, as described above, transactions from consumers to the merchant 22, such as credit card transactions, are processed and aggregated by merchant processor 24. Merchant processor 24 periodically submits these transactions, for example in the form of an ACH file, to the acquiring bank 26, which in turn submits the ACH file to the network 20. Thereafter, funds are transferred interbank according to processes specific to the network 20.

Recall, in providing card services to the merchant 20, the merchant processor 24 maintains a record of a merchant account identifier, such as a bank account number and routing number, designated by the merchant into which funds from daily sales should be deposited. While there may be many steps in transferring the funds, some of which were described above but all of which are well understood, the net effect is that the merchant receives funds in the merchant designated account indicated by the merchant account identifier.

The repayment system 10, in communication with the network 20, includes at least one merchant designated account 12, a master account 14, and an obligation processor 16. The entirety of funds are transferred to the merchant designated account 12 associated with the merchant 22 as specified by the merchant account identifier. The term “entirety of funds” means all of the funds due to the merchant. In the normal course of business, this includes the totality of sales but may be reduced by fees that are normally charged by the merchant processor 24, the acquiring bank 26, the network 20, or any other party involved in the transaction.

The merchant designated account 12 may be an account at a bank or more than one bank. The master account 14 may be an account at the same bank as the merchant designated account 12, or an account at a different bank. If the master account is at a different bank, then the merchant designated account 12 and the master account are in communication by way of a network capable of electronic funds transfer, like network 20.

Also, obligation processor 16 may be at the bank of the merchant designated account 12, at the bank of master account 14, or may be separate from the banks and in communication with the bank(s) of the at least one merchant designated account 12 and master account 14 by way of a network, such as the internet, or any other public or private network capable of transmitting and receiving electronic data.

Obligation processor 16 determines a first amount to remove from the merchant designated account 12 associated with merchant 22 according to a merchant's obligation. In one example, the merchant's obligation is a loan or cash advance. In another example, the obligation is for an amount for payment for capital goods due a supplier. The obligation must be repaid under agreed upon terms, such as a period of time, and the first amount is computed according to these and other terms of the obligation, as will be disclosed in greater detail.

The obligation processor 16 monitors the deposits into the merchant designated account(s) 12. For example, on a periodic basis, obligation processor 16 receives a file comprising records of all deposits into the merchant designated account(s) 12. The processor may monitor the deposits in many different ways, such as receiving files, requesting files, polling, interrupts, and the like. Obligation processor 16 maintains a database 17 of merchant obligations and the terms of the obligations. For each merchant, according to the obligations and the deposit into the merchant designated account 12, the obligation processor 16 computes the first amount. The first amount may be applied to principal, interest, and various fees.

The obligation processor 16 directs the first amount to be transferred out of the corresponding merchant designated account 12, and into the master account 14. If there is more than one merchant designated account 12, the first amount may be different for each merchant designated account 12. In transferring the first amount from each corresponding merchant designated account 12 to the master account 14, the processor may create a file of all required transactions, such as an ACH file, and submit it to the corresponding bank(s) at which the merchant accounts 12 are maintained.

The master account 14 may belong to the entity to whom the merchant has an obligation, such as a lender. In this way, some or all of the obligation of each merchant is satisfied when the first amount is transferred to the master account 14. There may be more than one master account 14.

The funds remaining in the merchant designated account(s) 12 after the transfer of the first amount are transferred to a bank account 28. The obligation processor 16 stores in its database 17 an account identifier for the bank account(s) 28 associated with the merchant designated account 12. The transfer is by way of network 20 or similar, such as an ACH network. The bank account 28 may be, for example, a bank account of the merchant and used by the merchant for daily business, accessible by the merchant at a local branch or online, and the like. It is appreciated that other fees may be transferred from the merchant designated account 12 or master account 14 to other entities of the retail payment system, such as for the payment of fees.

Periodically, such as each day, funds are transferred into the merchant designated account(s) 12 as a result of daily transactions, the obligation processor 16 transfers a first amount from each merchant designated account 12 to the master account 14 and the remainder in each merchant designated account 12 to the bank account 28. The first amount is computed anew with each daily transaction according to the obligation(s) and the daily transactions. In this way, the merchants pays his obligation from daily transactions.

In reference to the files that may be transferred between the merchant designated account(s) 12, the master account 14, and the obligation processor 16, any protocol may be used for the transfer of files, such as a file transfer protocol (FTP). The file transfers may be made secure through encryption.

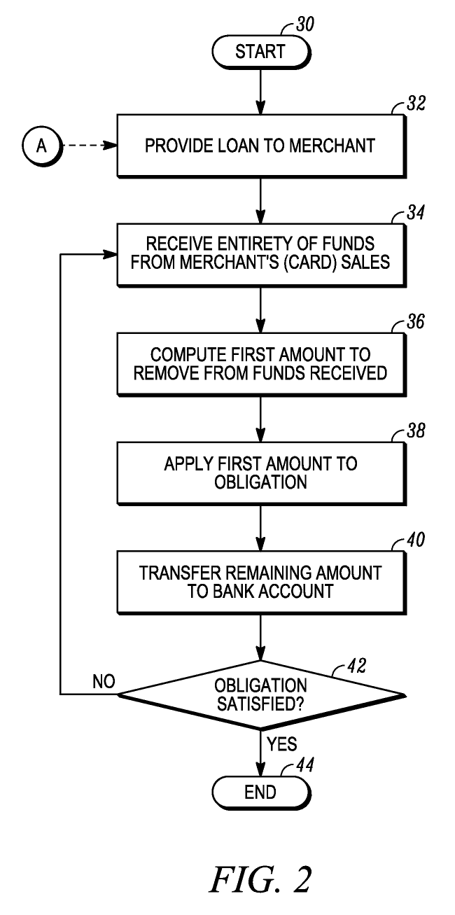

With the above disclosure in mind, FIG. 2 shows one exemplary method of repaying an obligation. The obligation may be any obligation, but in this example it is a loan or cash advance. Another type of obligation is an obligation to pay an amount for capital goods due a supplier from the merchant, or an obligation to pay an amount for any type of goods or services. At step 32, the loan is provided, that is a lender provides the loan to the merchant. For example, the amount of the loan may be deposited into the bank account (28 of FIG. 1) for immediate use by the merchant (22 of FIG. 1). It is understood that the term “loan” as used herein more generally comprises the supplying, furnishing, lending, or advancing of something that must eventually be paid for. In accepting the “loan”, the merchant has an “obligation” to repay the loan.

Over a period of time, for example a day, the merchant makes sales. The sales may be made with a card product such as a credit card. As disclosed above, the entirety of the funds from the merchant's sales are received at step 34. They are received in the merchant designated account (12 of FIG. 1).

Next, at step 36, according to the terms of the loan which includes, for example, the loan amount, the loan duration, the interest rate, and may also include other fees that may be due any other parties, a first amount is computed . The first amount is computed by the processor (16 of FIG. 1).

Then, at step 36 the first amount is applied to the obligation, that is, the loan. With reference to FIG. 1, the obligation processor 16 causes the transfer of the first amount from the merchant designated account 12 to the master account 14. In this example, the master account 14 is the account of the lender.

At step 40 of FIG. 2, the funds received at step 34 minus the first amount applied at step 36 is transferred to a bank account. Once again referencing FIG. 1, the obligation processor 16 causes the transfer from the merchant designated account 12 to the bank account 28.

At step 42, if the obligation is not satisfied, that is the loan has not been fully repaid, steps 34, 36, 38, and 40 are repeated until the obligation is satisfied (step 44).

In one example, the obligation of step 32 is a 180 day loan and has a fixed interest rate, in which case the first amount is computed (step 36) on a daily basis, each day for the term of the loan, according to the interest rate of the loan and daily funds received each day (step 34), and in order to ensure a complete 180 days duration. Since the daily amount of funds received (step 34) may vary from day to day depending on daily sales of the merchant, the first amount will also vary from day to day (or whatever the frequency of payment is) in order to ensure that payment extends fully over the entire 180 days. In this way, the loan repayment schedule is optimized to ensure loan duration. In another example, the loan repayment schedule is optimized to guarantee a yield. Other optimizations are possible such as optimizing to maintain a steady daily withholding amount or percentage from the merchant.

In repeatedly computing the first amount (step 36) to ensure payback of the obligation according to the terms, the funds received typically vary from day to day (or whatever the length of the period is). When receiving the entirety of funds (step 34 of FIG. 2) the obligation processor 16 receives a file comprising records of all deposits into the merchant designated account(s) 12, and thereby can create a history in the database 17 of all merchant transactions, for example all credit card transactions. In computing the first amount (step 36) this history may be analyzed and sales trends predicted for the merchant based on the transactions. The analysis and predictions can be further used to compute the first amount (step 36).

As mentioned, there may be more than one merchant and thus multiple merchant designated accounts 12(1) through 12(n). So, in creating a history as described above, a plurality of histories of a plurality of merchants may be created and stored in the database. These plurality of histories may be analyzed individually or in combination. In one example, the plurality of histories is analyzed to discover statistically significant information, such as credit card acceptance rates for merchants in a geographic area, performance of merchants by geography, by industry, chargeback rates, transaction volumes, seasonally based statistics, and other information.

The results of the history analyses may be used for identifying and marketing loans to other merchants that may be receptive to or in need of loans, or low risk borrowers. Thus, the lender can identify trends useful for marketing purposes, and target potential merchants for financial products. The analyses may be packaged and sold as a data source to interested parties, such as lenders, industry research groups, and the like.

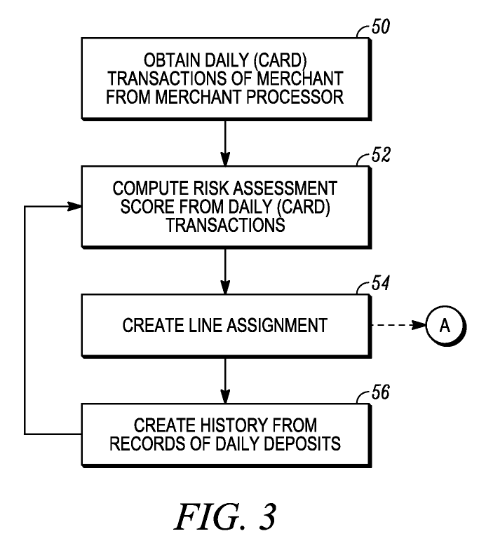

FIG. 3 illustrates a method for dynamic underwriting based on electronic transactions such as card transactions. Prior to providing a loan to a merchant (step 32 of FIG. 2), it is determined if to provide the loan and the terms and conditions of the loan. This determination is made based at least in part on the historical transactions, such as credit card transactions, of the merchant. While a history can be created once the merchant has been given the loan and payback has commenced (FIG. 2), the processor (16 of FIG. 1) has no such history for new merchants applying for a loan, except for the history for related merchants and industries as described above.

So, at step 50 of FIG. 3 the daily historical transactions of the merchant applying for the loan are obtained from the merchant processor. In applying for the loan, the merchant provides authorization, through the obligation processor 16 that permits the obligation processor 16 to electronically obtain from the merchant processor reports of the daily transactions of the merchants. These reports can be obtained by way of a network, such as the internet, but in the simplest case, may even be faxed or mailed to the lender and entered into the obligation processor 16. The reports may include many weeks or months of daily transactions, and may further include card types and details on chargebacks, and the like.

At step 52, a risk assessment score is computed from the daily transactions. The totality of the daily transactions are analyzed, and the analyses may include an extremely fine analysis to determine, for example, hourly trends for transactions, monthly trends, or seasonal trend. Thus, a risk assessment score is computed and is a function of the totality of daily transactions, and furthermore may be a function of industry sales history, geographical histories, personal and business credit bureau scores, prior histories with lenders, and the like.

At step 54, a line assignment is created according to the score of 52 and, by extension, the totality of transactions. The line assignment defines the loan by setting the amount of the loan, the duration of the loan, the discount rate, and the daily withholding. Line assignments may also include upfront fees, periodic fees, other fess, reserves, and the like. With this line assignment, a loan is provided to the merchant (step 32 of FIG. 2).

While the obligation is in repayment (FIG. 2), a history from the records of daily deposits is created step 56, as described with reference to step 34 of FIG. 2. This history is in turn used to repeat step 52, computing the risk assessment score, and step 54, creating a line assignment. Thus, the line assignment is dynamic, that is it is modifiable. Upon modifying the line assignment, the first amount computed at step 36 of FIG. 2 varies to ensure that the obligation is satisfied according to the modified line assignment. For example, in an extreme case, if during repaying, analysis of the merchant's sales predicts a drop in sales, thus affecting the score of step 52, the lender may desire to call in the loan early. In this case, the duration of the loan of the line assignment is shortened and the daily withholding may be increased, which causes the first amount computed at step 36 to increase as a percentage of the entirety of funds received at step 34, which causes the obligation to be paid off faster (step 38), and results in the merchant receiving less money for its daily sales (step 40). Those skilled in the art will appreciate that there are many other variables and analyses that may be used to compute the risk assessment score and dynamically create line assignments.

To review and turning to FIG. 1, in repaying the obligation (FIG. 2), funds are transferred to a merchant designated account 12 corresponding to the merchant that owes the obligation, for example the merchant that received the loan. As discussed as a matter of background, the merchant processor 24 maintains a record of a merchant account identifier, such as a bank account number or routing number, designated by the merchant into which funds from daily sales should be deposited, that is the merchant designated account 12.

In situations where the merchant may have an existing bank account 28 separate from the merchant designated bank account 12 prior to incurring an obligation, but the merchant still desires to incur the obligation (e.g. receive the loan) while retaining the bank account 28, the merchant may have to change the merchant account identifier stored by the merchant designated account 12 to redirect the funds to the merchant designated account (12).

To provide a little more background, the merchant 22 may be interfacing with the merchant processor 24 through a third party that sells the merchant services, but does not actually provide any services of the merchant processor 24. The third party is a middle man. So, a merchant 22 may not know who their merchant processor is, their procedures, or may find it cumbersome to interact with the third party middleman. Also, there are many, perhaps 150 or more, merchant processors and third parties, each operating in some respects differently from the other (although ultimately complying with the regulations and procedures of the associations' products and services they are representing, such as Visa and Mastercard, and acquiring banks). A lender may desire to make the loan process as easy as possible for a merchant.

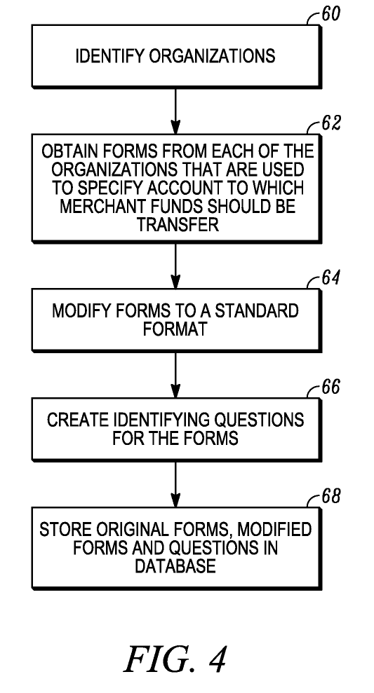

FIG. 4 shows a method for creating a merchant processor identifier database. At step 60, the organizations (third parties and merchant processors) are identified. At step 62, forms are obtained from each of the organizations. The forms are used to specify the merchant designated bank account used for transfers by way of the merchant account identifier. The forms may vary from organization to organization. The forms may comprise a paper form, or they may comprise a procedure for specifying the merchant account identifier electronically, via fax, via phone, or via mail through the paper form. Thus, as used herein, the term “form” is more generally understood to include procedures, whether those procedures are electronic or not.

Next, at step 64 the forms are modified into a standard format. At step 66 identifying questions are created whose answers uniquely identify a form from each organization, the form ultimately corresponding to a procedure of the actual merchant processor. Some exemplary questions include “What is the customer service number on statement you receive for your merchant services?”, “What is the name on the top of the merchant statement?, and “What is your merchant ID number?”. It is appreciated that there are many other questions that can be used to identify the actual merchant processor. At step 66 the original forms, the modified forms, and the questions are stored in a database such as database 17 of FIG. 1. Additional information may also be stored in the database such as procedures for executing the form.

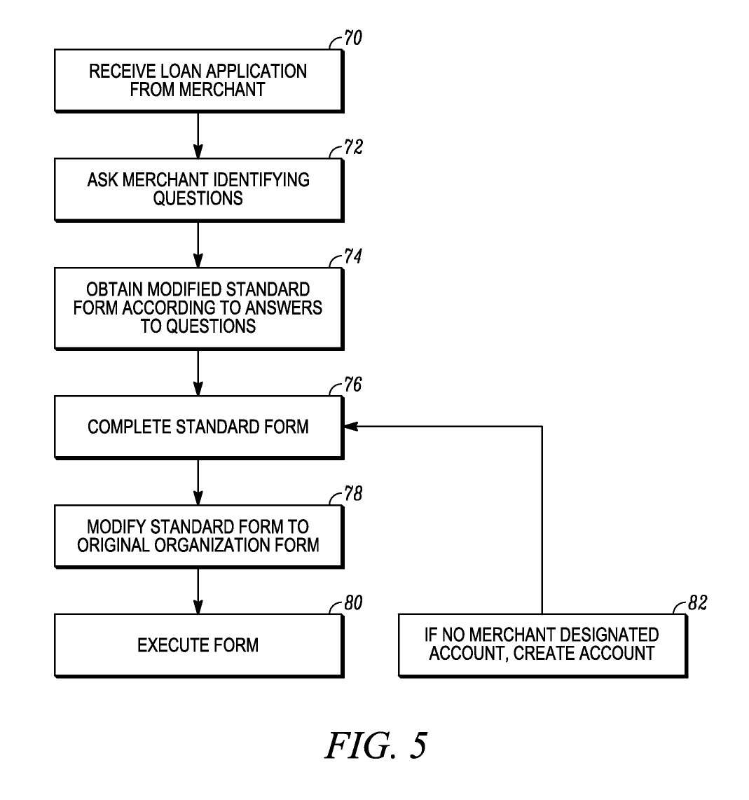

FIG. 5 illustrates a method of identifying a merchant processor and specifying the redirection of funds to a merchant designated account. The method of FIG. 5 uses the merchant identifier processor database of FIG. 4.

At step 70 a loan application is received from a merchant. At step 72 the merchant may be asked at least some of the identifying questions stored in the database. The identifying questions may be included in the loan application received from the merchant. The method may include receiving more general loan application information from the merchant, and then asking the merchant more specific questions.

Based on the responses from the merchant, a modified standard form is obtained from the database at step 74. Since the modified form has a standardized format, a lender can more easily and efficiently complete the standardized form. The same applies if merchant is applying using an automated on-line system. In completing the standard form, if the merchant does not have or does not specify a merchant designated account, such an account is created, step 82. As seen in FIG. 1, there may be multiple merchant designated accounts 12(1) through 12(n) and these are dynamically created by the obligation processor 16 prior to or upon providing the loan. Similarly, once the merchant has satisfied the obligation, the obligation processor 16 may close the associated merchant designated account 12.

Next, at step 78 the standard form is modified back to its original organization specific form. If it is a paper form, the standard paper form may be electronically generated and printed as the organization specific form. If it is an electronic form, the standard procedures may be modified to comply with the organization specific form. At step 80, the form is executed. For example, the form may be mailed, emailed, transmitted according to some other electronic procedure, faxed, or a phone call may be initiated to the organization according to the proper procedures for that organization. The steps of FIG. 5, in whole or in part, may be by way of computer, other machine, or person, depending on the specific form required by the organization.

Now, turning back to FIG. 1, as already disclosed, there may be more than one master accounts 14. Additionally there may be one or more reserve or collateral accounts corresponding to one or more of the merchant accounts 12. In this case the first amount computed at step 36 of FIG. 2 and applying the first amount at step 38 of FIG. 2 may include transferring funds to the appropriate reserve or collateral account. Similarly, there may be third party accounts for payments to third parties. Also, a second amount may be computed in FIG. 2 for the payment of fees or other obligations to third party accounts.

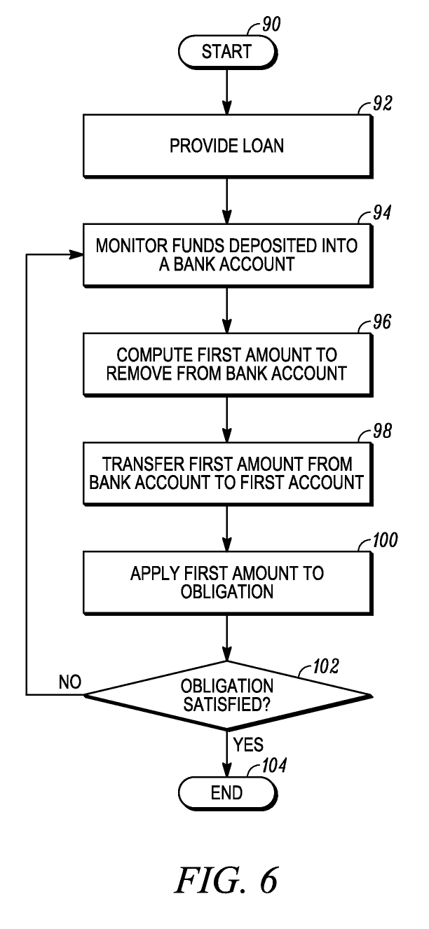

Keeping in mind the discussions with reference to FIGS. 1 and 2, FIG. 6 shows another exemplary method for repaying an obligation. At step 92, a loan is provided. In this method and as a matter of background, the funds from the merchant's sales are periodically deposited into a bank account, such as bank account 28 of FIG. 1, as directed by merchant processor 24.

At step 94 the funds deposited in the bank account are monitored (step 94), for example obligation processor 16 receives a file periodically. At step 96, a first amount is computed according to the terms of loan.

At step 98 the first amount is transferred from the bank account to a first account. The first account may comprise, for example the master account 14 of FIG. 1. As an additional step, the first amount may be transferred from the bank account to a second account, and then from the second account to the first account. For example, the second account may comprise a merchant account (12 of FIG. 1), and the first account may comprise the master account (14 of FIG. 1).

At step 100 the first amount is applied to the obligation. At step 102, if the obligation is not satisfied, steps 94, 96, 98, and 100 are repeated until the obligation is satisfied (step 104).

In the case where there are not sufficient funds in the bank account to transfer the first amount, or any owed amount for that matter, (step 98), the first amount is not applied to the obligation (step 100). In this case, step 98 may be repeated periodically. If the transfer(s) of step 98 fails, for example due to insufficient funds, the merchant having the obligation, and in default of the obligation may be flagged and any prior art collection process may be initiated, such as selling the debt to a collection agency, and the like.

Finally, the disclosed systems and methods, and modification thereof may be implemented on any conventional computer using any array of widely available and well understood software platforms, programs, and programming languages. For example the systems and methods may be implemented on an Intel or Intel compatible based computer running a version of the Linux operation system or running a version of Microsoft Windows. One or more computers may be used for the merchant designated accounts 12, the master account 14, and the obligation processor 16. The computers may include any and all components of a computer such as storage like memory and magnetic storage, interfaces like network interfaces, and microprocessors. A computer program product may include a computer readable medium comprising computer readable code which when executed on the computer causes the computer to perform the methods described herein. The database 17 of FIG. 1 may be part of the obligation processor 16 or may be a separate computer in communication with obligation processor 16 by way of a network. The database may be any conventional database such as an Oracle database or an SQL database. These components of the computer, including creating, storing, modifying, and querying databases, and interfacing and communicating with networks are well understood by those having ordinary skill in the art.

The foregoing detailed description has discussed only a few of the many forms that this invention can take. It is intended that the foregoing detailed description be understood as an illustration of selected forms that the invention can take and not as a definition of the invention. It is only the claims, including all equivalents, that are intended to define the scope of this invention.

What is claimed is:

1. A method for repaying an obligation comprising:
(a) periodically receiving into a merchant designated account an entirety of funds resulting from merchant sales made with a card product;
(b) computing a first amount related to terms of an obligation;
(c) applying the first amount to the obligation;
(d) transferring the amount remaining in the merchant designated account after applying the first amount to the obligation to a bank account accessible by the merchant; and
(e) if the obligation is not satisfied, repeating steps (a) through (d).

2. The method of claim 1 wherein the period of the receiving in (a) is daily.

3. The method of claim 1 further comprising periodically varying the first amount.

4. The method of claim 3 the period of the varying is daily.

5. The method of claim 3 further wherein the varying comprises varying according to at least one of sales history or sales predictions.

6. The method of claim 3 further wherein the varying comprises varying to optimize for at least one of the terms of the obligation.

7. The method of claim 1 wherein the applying in (c) comprises transferring the first amount from the merchant designated account to a master account.

8. The method of claim 1 further comprising, before the step of receiving in (a), providing an obligation to the merchant.

9. The method of claim 8 wherein the providing an obligation comprises depositing money into a bank account accessible by the merchant.

10. The method of claim 8 wherein the obligation comprises at least one of the following: a loan, a cash advance, an obligation to pay an amount for capital goods, an obligation to pay an amount for goods or services.

11. The method of claim 8 wherein the providing comprises determining if an obligation should be provided, at least in part by analyzing a card product transaction history of the merchant.

12. The method of claim 8 wherein the providing comprises:
obtaining historical card product transactions of the merchant applying for the obligation;
computing a risk assessment score based on the historical card product transactions;
creating the terms of the obligation according to the risk assessment score; and
if the obligation is in repayment, periodically re-computing the risk assessment score using card product transaction data obtained during repayment, and modifying the terms of the obligation according to the re-computed risk assessment score.

13. The method of claim 1 further comprising creating additional merchant designated accounts, each additional merchant designated account corresponding to an additional merchant having an obligation.

14. The method of claim 1 further comprising transferring at least some of the first amount to a merchant reserve account.

15. The method of claim 1 further comprising computing a second amount related to an obligation owed to a third party.

16. A method for repaying an obligation comprising:
(a) providing an obligation to a merchant, the providing comprising determining if the obligation should be provided, at least in part by analyzing a card product transaction history of the merchant, the providing further comprising, if the obligation should be provided, depositing money into a bank account accessible by the merchant;
(b) periodically receiving into a merchant designated account an entirety of funds resulting from merchant sales made with a card product;
(c) computing a first amount related to terms of an obligation, the computing comprising periodically varying the first amount;
(d) applying the first amount to the obligation, the applying comprising transferring the first amount from the merchant designated account to a master account;
(e) transferring the entirety of funds minus the first amount to a bank account accessible by the merchant; and
(f) if the obligation is not satisfied, repeating steps (b) through (e).

17. A system for repaying an obligation, the system in communication with a retail payment system, the system for repaying an obligation comprising:
at least one merchant designated account in communication with a network of the retail payment system;
a master account in communication with the at least one merchant designated account; and
an obligation processor in communication with the at least one merchant designated account and the master account.

18. The system of claim 17 further comprising a database for maintaining merchant obligation data.

19. The system of claim 17 further comprising at least one more master account in communication with the obligation processor.

20. The system of claim 17 further comprising a reserve account associated with the at least one merchant designated account.

21. The system of claim 17 wherein the network comprises an automated clearing house network.

22. The system of claim 17 wherein the at least one merchant designated account, the master account, and the obligation processor are co-located at a bank.

23. The system of claim 17 wherein at least some of the at least one merchant designated account, the master account, and the obligation processor are located at different banks, and are in communication with each other via a network.

24. The system of claim 17 wherein the obligation processor comprises:
means for monitoring deposits into the merchant designated account;
means for determining a first amount to remove from the merchant designated account associated with the merchant according to the merchant's obligation; and
means for directing the first amount to be transferred out of the merchant designated account and to the master account.

25. The system of claim 24 wherein the obligation processor further comprises means for transferring the funds remaining in the merchant designated account, after the first amount is transferred, into a bank account accessible by the merchant.

26. The system of claim 25 wherein means for transferring comprises transferring via an automated clearing house network.

27. The system of claim 24, further:
wherein the deposits are the entirety of funds of all daily transactions made at a merchant with a card product; and
wherein the first amount is re-computed according to the obligation and the daily transactions.

28. A system for repaying an obligation, the system in communication with a retail payment system, the system for repaying an obligation comprising:
at least one merchant designated account in communication with a network of the retail payment system;
a master account in communication with the at least one merchant designated account; and
an obligation processor in communication with the at least one merchant designated account and the master account, the obligation processor comprising,
means for monitoring deposits into the merchant designated account;
means for determining a first amount to remove from the merchant designated account associated with the merchant according to the merchant's obligation;
means for directing the first amount to be transferred out of the merchant designated account and to the master account; and
means for transferring the funds remaining in the merchant designated account, after the first amount is transferred, into a bank account accessible by the merchant.
